(19) United States
(12) Patent Application Publication
(10) Pub. No.: US 2020/0211423 A1
(43) Pub. Date: Jul. 2, 2020

(54) METHOD AND APPARATUS FOR REMEMBERING PASSWORDS WITH LEAST AMOUNT OF MEMORY

(71) Applicant: Lihui Wang, Wuhan, Hubei (CN)

(72) Inventor: Lihui WANG, Wuhan, Hubei (CN)

(21) Appl. No.: 16/609,156

(22) PCT Filed: Apr. 28, 2017
(86) PCT No.: PCT/IB2017/000489

§ 371 Date: Oct. 28, 2019

(51) Int. Cl. G09C 1/04; G06F 21/36; G06F 21/34; G09G 5/26; G09G 5/39; G06K 15/02

(52) U.S. Cl. CPC G09C 1/04; G06F 21/36; G06K 15/028; G09G 5/26; G09G 5/39; G06F 21/34

(57) ABSTRACT

Disclosed are a method and apparatus for remembering passwords with the least amount of memory, overcoming the disadvantage that previously, passwords or fixed codes, such as credit card numbers, were inconvenient to record and difficult to remember. People's long-term memories regarding ethnic characters, letters, digits and patterns are used; one or two of the above are selected to intersect with blank units or information code matrices, the contents of which can be changed by characters to be set, so as to obtain coincident points and non-coincident points; according to the step of reading information thereabout as specified or according to the steps of filling in, confusing and re-finding fixed codes, passwords or the fixed codes are obtained; regarding a mechanical apparatus, a key, on which an imprint is left by means of pressing a character, can be expanded into long chains, two chains are matched to obtain more logic states, and a plurality of passwords are obtained by means of reading and segmentation as specified; regarding an electronic-type apparatus, three three-colour light-emitting diodes are connected to symmetrical switch buttons to form a matrix template; digits, capital letters and small letters and symbols to be set printed on the template are displayed; according to light colours of the light-emitting diodes and whether same are in a light-emitting state, information codes are arranged as specified; and a canonical character model ensures that the passwords or the fixed codes obtained every time are the same as those set before.

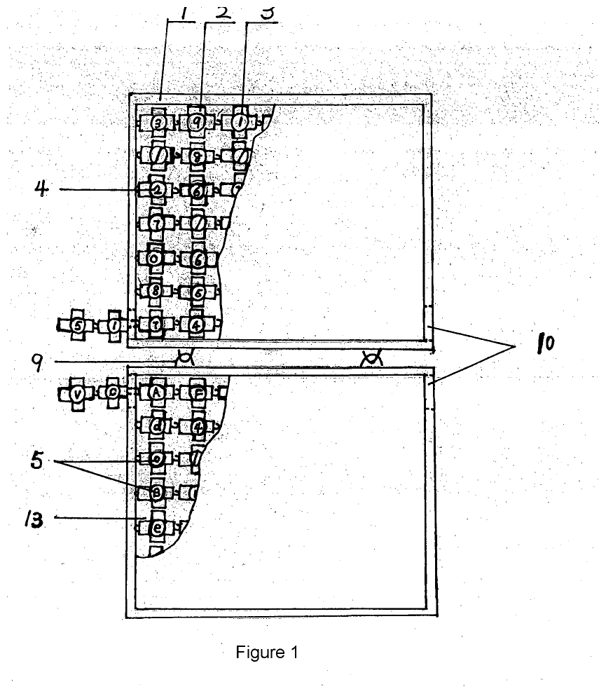

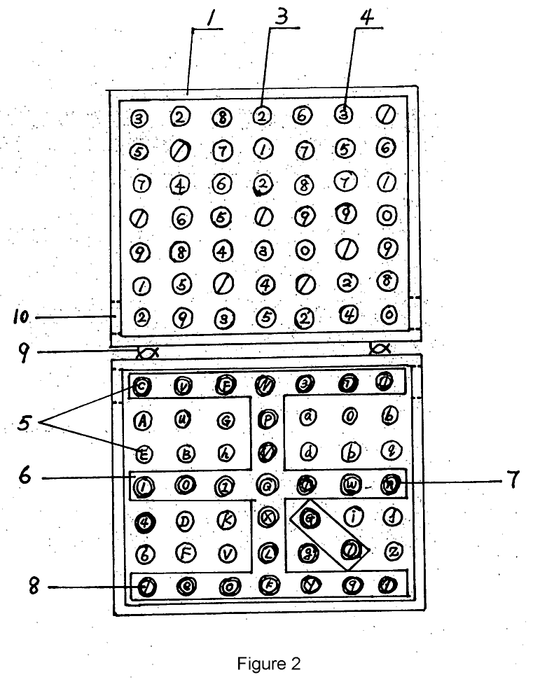

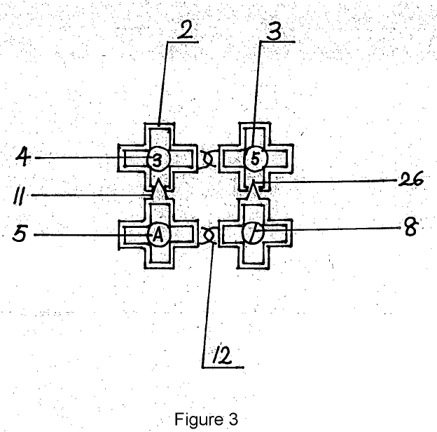

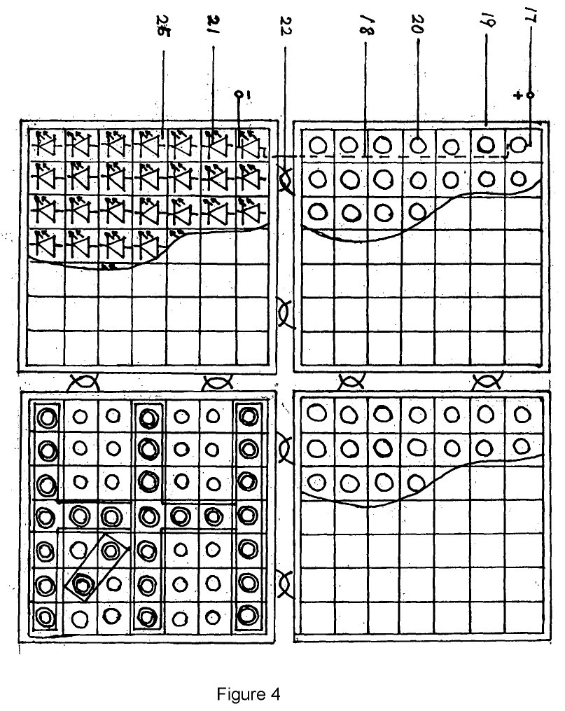

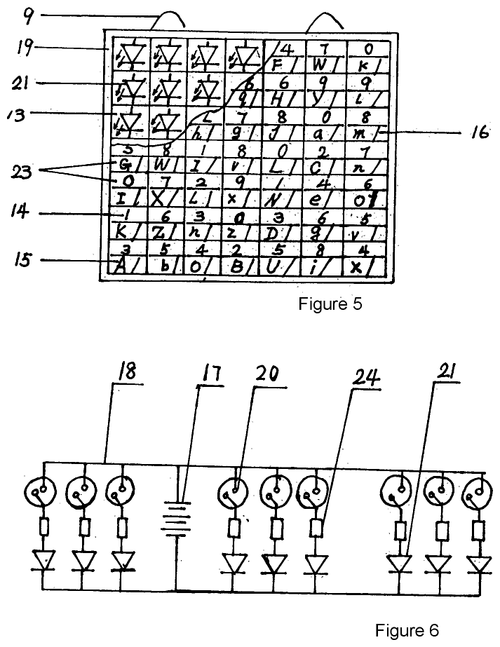

### THE TECHNOLOGICAL AREA

this invention refer to a method and apparatus for remembering passwords with the least amount of memory, which help people firmly remember long or complicate, one or more passwords or fixed codes, and all other various types of information codes sequence.

### THE TECHNOLOGICAL BACK GROUNDS

so far, in any market, there is no such a method or apparatus to help people to remember passwords or fixed codes with few of memory, but its needs are everywhere such as bank cards, credit cards, mobiles, computers or safe cases etc. where always something need to be memorized. Everyone want set up a long and complicate password to improve a safety degree for their properties, documents or information etc., but the more complicate, the more difficult to remember especially under same conditions of persons, such as older, having a bad memory etc. On another hand, because of a character of a password or fixed codes, it is not properly to be marked on a notebook, or to store up in the memory of a mobile or a computer. Beside, once a place, sphere for a password or fixed codes is fixed, then it may be very ease to be broken down by a method of ‘digital combination’, such as a code-lock.

### THE CONTENTS OF THE INVENTION

in this invention, two methods and two apparatuses make people all no need to remember such a senseless numbers, letters or symbols etc. but through the methods and apparatuses provided here plus a bit memory, then any kind of passwords or fixed codes either set up before by a user or recorded previously all can be re-found easily disregarding a person's features, such as, older or young, having good or bad memory, high or low education lever; and disregarding a outer conditions, such as, a long or complicate fixed codes, the long time past from a usage previously.

There are two methods to realize this invention with only a backward step making a mainly difference during the operation. In method one: using numbers, capital or small letters, symbols, or all other information codes form a matrix plane, or a information codes template, where the contents of an assignments-awaiting-symbol are assigned by a user to make information codes appearing on the a template incompletely, then nobody will know what a exact sphere of all content of a information codes sequence well but a user, then a method of ‘the digital combination’ try to break down a information codes sequence may be prevented by this time because of this special symbols; then taking ethnic words, letter words, numbers or patterns etc. formatted by standard lines as a character unit, which are very familiar by people and belong to people's long term memory as well; then one or more such a character units or a character model built by these one or more character units will be laid on the information codes template, then the lines (or holes on the lines) on the character model and matched information codes must intersect or coincide to produce coincident points, then two logical states as coincident and non-coincident points will be appearing on the coincided template; assign a logical state, assign a content of assignment-awaiting-symbol, such as one or two of numbers, letters or symbols, assign a direction of beginning to scan coincident points or non-coincident points and assign an arranged order for these points, such as, beginning with a horizontal direction on a coincided template, from left to right, from up to down, or beginning with a vertical direction, from up to down, from left to right, orderly read the information codes from coincident or non-coincident point, then a password is set up for a user; if move the non-fixed codes out of the coincident points in exchange the fixed codes outside then a fixed password or a fixed codes will be refound.

In short, once attach a irregular digit codes or character codes to a regular character model, a great memories burden will become few memory, such as, as little as one or two character and one or two of numbers, letters or symbols. the information codes on a template can be connected one by one to expand to a strait long chain so that a reading or scanning for coincident or non-coincident points will be more in convenience. Two such chains may be connected side by side to build more logical states and obtain more passwords by combining and segmenting them according to an assignment.

Realizing this invention with method two: this method two will fit a fixed codes very well. The fixed codes is a unchangeable, fixed digit or character codes, which may be not only hard to remember, but also may be not convenient to be market on anywhere, such as a credit card's number. On a plane, set up a matrix by many blank units, or in formation codes with a fixed codes among them. Lay a standard character model built at least one character unit on the blank matrix plane, some coincident points will be obtained by a coincidence of lines or holes on and the blank units. An assigned arrangement order for coincident points is that, on a coincided blank units matrix plane, beginning from a horizontal direction to scan the coincident points from left to right, from right to down, or with beginning from a vertical direction from up to down, from left to right, etc., let the fixed order match the order of coincident points, fill the fixed codes into the blank units one by one where the coincident points are. All other blank units beside this fixed codes are filled with any digit or character codes with similar information codes' type as that fixed codes. By this time, moving away a character model equal moving out the limit, all real information codes will be confused by other unreal information codes on the template. For example, there is a symbol ‘+’ as a character unit, as well as a character model, put it on a blanks matrix plane as 5×5, according to an assigned arrangement order of the coincident points, begin scanning the coincident points from a horizontal direction, from left to right finding the first coincident points at the first horizontal line and the third vertical line, the first code of the fixed codes ‘1’ as the first of given digit codes ‘123456’ will be filled in there; then from up to down finding the second points at the second horizontal line and the third vertical line, then the second fixed code ‘2’ will be filled in there according to the order of a fixed codes match the order of coincident points; then 4 out of the 5 coincident points on third horizontal line will be filled with fixed code ‘3456’, then all rest blank units will be filled in any pure number to function a confusion. Moving away the symbol character model ‘+’, make a mark to the matrix pattern this time on the template, late, when put the symbol ‘+’ back to this marked matrix template next time, the fix codes ‘123456’ will be re-find very easily, according to the order of scanning the coincident points.

If on a information codes template, a fixed codes is already included, just move those non-fixed codes out of the holes of a character model in exchange the fixed codes outside, arrange the codes in the holes according to the order of the fixed codes match the order of the coincident points. Assignment-awaiting-symbols may also include on template as one of the fixed codes or a useless code.

There are two kind apparatuses, mechanical type and electronic type to practices the methods above. On a mechanic type, a box folio onto at least one half of the box, where some short chains consist of some movable bottom-blocks-casings and are set up inside each of half the box according to sizes of the each halves of the box; each movable keys with information codes are movable set in each casing above which will be obvious lower than the others when press them down, and they will back to a normal position by press them again, The keys with pure number and asignment—awaiting-symbols may be set in one half of the box; and the keys with numbers, capital or small letters and assignment-awaiting-symbols will be set in another half-of the box to form at least one keys template, some standard lines form a character unit, one or more such units build a character model through some way of structures. When such a character model is laid on the keys template, its holes on each line will hold on each matched keys to form the coincident points by holes and matched keys coincidence.

There are openings on each side of the halves of the box with the shortest distance between two openings on the same side; the sizes of the openings are suitable for the bottom-blocks-casings so that can be pulled out easily to form a straight long chain, which will make reading and scanning on high or low keys in more convenience; two of such chains can be connected side by side to make more logical states And more passwords

When set up a keys template for a matched fixed codes, move non-fixed code out of the holes, or out of the lower keys, in exchange the fixed codes outside, arrange the fixed codes in the holes or on the lower keys according to the order of fixed codes match to the order of the holes or the lower keys order, what a information codes be scanned is the fixed codes; move away the character model, bring the lower keys back to normal, make a cope to this keys matrix pattern on the template for next time to using.

At electronic type apparatuses, the principle of circuit is that: inlet wire for each switch button connects to the positive pole of a power, and outlet wire for each switch button connects to the positive pole of a symmetrical light-emitting-diode through a resistance, thus each loop circuit is built, and many such loop circuits parallel at two ends of the power. Several movable seating-frames are divided onto many square units inside, when each two of seat-frame cover over another two, a box is formed; many such switch buttons form each special matrix template, or switch buttons templates, each light-emitting-diodes is mount on the top of each square unit to form another special matrix template, or display template; all unit are symmetry each other on different templates with every three units from three switch button switch buttons template symmetry to only one unit on display template, so every three switch buttons' outlet wire must go to that single light-emitting-diode on display template, which has its own symmetrical units to those three units according to a policy each of every three buttons from each of three template must be symmetry each other and connect their wires to the symmetrical single diode in its unit on display template. A top lids consist of two halves of the lid with information codes to form a half of the lid matrix template; three switch buttons template are covered by either a same character model or different character model, switch on the switch buttons by press them down in each holes, then the matched diodes on display template must emit light to show a sphere of a fixed codes or a fixed password. If three switch buttons templates represent three kinds information codes separately as numbers, capital and small letters and assignment-awaiting-symbols, then when input each one of the fixed codes by press down each matched switch button on three buttons template is for that a matched type of information codes between fixed codes and three template.

So taking three same or different character model cover over the three switch buttons templates, press down each of the buttons matching to each place and type of each code of the fixed codes and each coincided holes from the character models. On display template, move half of the lid of non-fixed codes out of the light-emitting in exchange half of the lid of the fixed codes from outside, arrange each of the half of the lid of fixed codes on the light-emitting according to an assigned arrangement order of light-emitting, that may be beginning from a horizontal direction to scan light-emitting from left to right, from up to down; or beginning from a vertical direction to scan the light-emitting from up to down, from left to right; move some other halves of the lid out beside this halves of the lid of fixed codes but keep some suitable one for confusion purpose. Switch off all switch buttons on three switch buttons templates, make a cope to a halves of the lid matrix pattern this time as a halves of the lid template match to that fixed code which can be re-found back anytime late by switch on switch buttons, scan the light-emitting in order and read the information codes from halves of the lid at the points of light-emitting.

Because there are two kind of information codes are displayed on the same half of the lid as ‘a/’, so when scanning the light-emitting and read the information codes, switch off the switch button on letter's template will test if the information codes on that half of the lid is letter ‘a’ or symbol ‘/’; do the same to switch buttons on assignment-awaiting-symbol's template will test the same thing.

The electronic type can be upgraded to computerization, a flow chart is as following: Touching on a screen—Coming up some character—To choose one or two of them—Giving out matched templates—To choose one in need—Doing coincidence and scanning by the computer—displaying a password or a fixed codes.

### THE ILLUSTRATION TO ATTACHED CHARTS

Chart 1 is a top view of a part of bottom-block-casings for mechanical type about the least memory for remembering passwords.
Chart 2 is a top view that take a character model cover over a keys
template, for a mechanical type, but omit all of the bottom-blocks—casings out.
Chart 3 is a top view where bottom-blocks-casings connected one by one.
Chart 4 is a top view where a character model cover over one of the switch button template but show only a part of switch button on two template and only a part of light-emitting-diodes on the display template for electronic type apparatus.
Chart 5 is a top view of a part of halves of the lid with information codes on a matrix template,
Chart 6 is a wires connection chart for the circuit between templates.

### A DETAIL DESCRIPTION OF THE INVENTION

a mechanical apparatus for remembering passwords with the least memory, a folio box 1, bottom-blocks-casings are connected by hooks 12 and are set in each half of the box, keys 3 are with information codes, some of them are lower than others when press them down but they will be resumed by pressing them again.

Some of the keys are set in one half of the box as a pure numbers 4 and assignment-awaiting-symbol 8 as a kind of information codes as a keys matrix template; some of the keys 3 are set in another of the box with capital and small letters 5, numbers 4 and assignment-awaiting-symbols 8, to form keys template 13, a character unit consist of standard lines are ready to build any character model 6, its holes 7 hold on matched keys 3, when pull them out of the opening 10 according to an assigned direction, a straight long chain will be formed, read the information on high or low keys to obtain the password; two of these chains hold each other by opening 11 and a opening 26, by combining a logical states from two chains, more passwords may be obtained.

For electronic type, several seating-frames 19 connected by hooks 22 and divided Into many square units 25, each switch buttons 20 or each light-emitting diodes 21 are set in each square unit to form several template 13, every three outlets wire 18 from every three switch buttons through three resistance 24 connect to a positive Pole of a symmetric light-emitting-diodes 21 on display template, as every three unit match to symmetrical one unit the hole 7 from standard character model 6 hold on matched switch buttons, all negative pole of light-emitting-diodes connect their wires to negative pole of a power 17, all inlet wires of light-emitting-diodes connect their wires to negative pole of the switch buttons; every two halves of the lid 23 with numbers 14, capital or small letters 15 or assignment-awaiting-symbols 16 etc. are mounted on each top of unit 25 of display template; all haves of the lid are movable.

Productive prospect: materials as metal or plastics for production are easy to obtained; the parts can be made as small as possible, such as, film switch button etc.; mechanical type are durable, and need no electricity; character models can be made by paper or print books, not only because its cheap materials but also its large capacity, a lots character models can be there for people to choose, but a standard of each character model matching to information codes templates are very important, so are the lines or holes on each line match to keys or switch buttons.

1. A method for remembering password with the least amount of memory, including digital codes, letters, symbols or all other Information codes form a matrix plane, and including words, numbers or patterns etc. as characters, the characteristics are these: on the matrix plane, some symbols are assignment-awaiting-symbols, which are waiting for its contents assigned by a user; and it will go with other digit codes, capital and small letters etc. together through changing information codes and arranged orders on the matrix plane to form at least one information codes templates; some standard lines of a character unit match a standard of arranging information codes into a matrix plane; at least one character is laid on information codes template, the lines on the character and information codes on the template intersect or coincide leaving some coincident points or non-coincident points on the template and lead to two logical state there also, read the information codes from coincident or noncoincident points according to an assigned order, a password in setting up is finished; if a fixed codes or a fixed password are not all in those coincident points or noncoincident points by this time, move correct codes to those coincident or non-coincident points according to an assignment, then any user's fixed information codes sequence or password will be re-found; information codes on a template may be connected one by one to expand as a straight long chain, two such the chains connected side by side will form more logical states and more passwords by combination, arrangement and segment according to an assignments.

2. According to the statement in the claim 1 about a method for remembering passwords with the least amount memory, the characteristics are these: one or more character model that is laid on one or more template may be all the same or not all the same.

3. According to the statement in the claim 1 about a method for remembering passwords with the least amount of memory, the characteristics are these: all assignments are about a logical state of coincident and non-coincident points, a content of assignment-awaiting-symbol, a direction of beginning to scan coincident or non-coincident points and an arranged order for those points.

4. According to the statement in the claim 1 about a method for remembering passwords with the least amount memory, the characteristics are these: a content of the assignment-awaiting-symbol is assigned as a number value when a password is a type of pure numbers or assigned as one of the numbers, one of the capital or small letters, or one of the symbols when a password is a mixed type.

5. A method for remembering passwords with the least amount of memory, including a information codes matrix plane, the characteristics are these: a matrix plane also consist of blank units; the standard for an arrangement of the lines of a character unit match the standard of forming the matrix of the blank units; at least one or character is laid on the blank units matrix plane, its lines or holes and matched blank units intersect or coincide to form coincident points, assign an arranged order for coincident and non-coincident points, let the fixed order of fixed codes match the order of coincident points to fill in the fixed codes one by one into blank units where the coincident points are, all rest of blank units are all filled in any information codes with the similar type to the fixed codes; move away the character, record this time a confused information codes matrix pattern on the template; when later put this same character back again, read the information codes limited by the character according to a same assigned arrangement order, the fixed information codes will be refound.

6. According to the statement in the claim 5 about a method for remembering passwords, the characteristics are these: after the lines on a character and matched blank units coincide or intersect, the assigned arrangement orders for coincident points include that, scanning coincident points on a coincided blank units matrix plane with beginning from a horizontal direction, from left to right, from up to down, or with beginning from a vertical direction, from up to down, from left to right.

7. According to the statement in claim 5 about a method for remembering passwords with the least amount of memory, the characteristics are these: some of the assignment-awaiting-symbols may be in the fixed codes or non-fixed codes, and its contends can be assigned as a useful or useless information codes; or if it is belong to the fixed codes or non-fixed codes.

8. (canceled)

9. (canceled)

10. (canceled)

11. (canceled)

12. A electronic-type apparatus for remembering passwords with the least amount of memory, including a few seat-frames divided into numbers of square units, the characteristics are these: each movable switch button is mounted in each square unit, and each light-emitting-diodes is amounted in other each symmetrical square unit, all these together as a few special templates, such as, three switch button templates may be treat separately as types of information codes as numbers, capital or small letters and assignment-awaiting-symbols, and a display template with each light-emitting-diodes in each square unit and each of two halves of the information codes lid on the top of each square unit to form a half of the lid matrix template also; each unit with its switch button on one switch button template is symmetry to another unit on another switch button template leading to all switch buttons on three templates are symmetry each other, and each of every three switch buttons from each of three templates will be symmetry to only one unit or one light-emitting-diode on display template; then every three outlet wires of the switch buttons must connect to positive pole of this symmetrical light-emitting-diode through three resistances, and every three inlet wires connect to power as well as all wires from negative pole of the light-emitting-diodes, thus many loop circuits are established, and also as a parallel circuit at two ends of the power; any fixed codes will have its match switch button on three template, so once switch on them, the symmetrical light-emitting-diodes must emit light, move all one half of the lid with non-fixed code out of the light-emitting in exchanging half of the lid with fixed code, then arrange them according to an assigned arrangement order of light-emitting match to the fixed order of the fixed codes, move away some half of the lid beside these fixed codes already at light-emitting, but keep some others to function cofussion, switch off all switch button on templates and make a cope to this half of the lid matrix pattern for re-find this fixed codes next time, that is switching on the switch buttons and scanning the half of the lid with information codes according to the assigned arrangement order of the light-emittings.

13. According to the statement in claim 12 about a electronic-type apparatus for remembering passwords with the least amount of memory, the characteristics are these: at any light-emitting, when a few information codes are showed within one half of the lid, such as ‘b\’, just go to one of the switch button template which are assigned as special assignment-awaiting-symbol template and switch off a symmetrical switch button there, then if a matched light-emitting on display templater is out, which means a real information code there is ‘\’ but not a ‘a’; if go to a capital or small letter template, it will test the same thing.

14. According to the statement in claim 12 about a electronic-type apparatus for remembering passwords with the least amount of memory, the characteristics are these: an assigned arrangement order for light-emitting will be that, scanning the light-emitting on display template with beginning from a horizontal direction, from left to right, from up to down; or with a vertical direction, from up to down, from left to right, etc. . . .
